(19) United States
(12) Patent Application Publication
(10) Pub. No.: US 2005/0251814 A1
(43) Pub. Date: Nov. 10, 2005

(54) OPTICAL DISK DRIVE WITH A DISC-POSITION SENSING DEVICE

(76) Inventor: Jui-Chiang Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/710,666

(22) Filed: Jul. 28, 2004

(30) Foreign Application Priority Data
May 10, 2004 (TW) 093207255

(51) Int. Cl. G11B 7/00; G11B 17/04

(52) U.S. Cl. 720/621

(57) ABSTRACT

An optical disc drive has a disc slot for a disc to be inserted into, a roller for conveying the disc inserted into the disc slot, and a disc-position sensing device having a plurality of sensing modules installed inside the disc slot for sensing a position where the disc is inserted into the disc slot. The roller does not convey the disc until all of the sensing modules have sensed the disc.

### BACKGROUND OF INVENTION

1. Field of the Invention

The present invention relates to an optical disc drive, and more particularly, to an optical disc drive with a disc-position detecting device.

2. Description of the Prior Art

In recent years, owing to the rapid development of digital technology, analog data such as video and audio data can be transformed into digital form for easy storage and transmission. Thus, there is an increasing demand for digital data storage media. Instead of conventional data storage media such as magnetic tapes and magnetic discs have relatively limited data storage capacity and are not adequate to store huge amounts of digital data, optical discs have therefore been developed to fill this need. And an optical disc drive is an electronic device used to access data stored in an optical disc.

Concerning disc loading, optical disc drives can be categorized into three types: top-loading clamshell design, tray-loading, and slot-loading. Having the advantage of conveying a disc in and out directly, slot-loading optical disc drives are becoming one of the most popular types of optical disc drives.

Please refer to FIG. 1, which is a schematic diagram of a slot-loading optical disc drive 10 capable of accommodating a large disc (ex. 12 centimeters in diameter) as well as a small disc (ex. eight centimeters in diameter) according to the prior art. The slot-loading optical disc drive 10 comprises a disc slot 12 for a disc to be inserted into, a roller 14 installed behind the disc slot 12 for conveying a disc 18 inserted into the disc slot 12, a sensing module 16 installed in a front area of the disc slot 12 for sensing the disc 18, a large disc data-accessing position 20 for accommodating a large disc, and a small disc data-accessing position 22 for accommodating a small disc. The roller 14 does not convey the disc 18 inserted into the disc slot 12 to the large disc data-accessing position 20 or to the small disc data-accessing position 22 until the sensing module 16 has sensed the disc 18.

The disc 18 shown in FIG. 1 is a large disc 18. In general, the disc slot 12 of the optical disc drive 10 is slightly larger in width than the large disc 18, so the large disc 18 cannot be inserted into the disc slot 12 unless it is inserted properly through a middle region of the disc slot 12. Therefore, the roller 14 conveys the large disc 18 inserted into the disc slot 12 to the large disc data-accessing position 20 without error. And the large disc 18 can be adequately rolled in without slipping.

Please refer to FIG. 2, which is a schematic diagram showing that the optical disc drive 10 conveys a small disc 24 inserted into the disc slot 12. As mentioned previously, the roller 14 does not convey the small disc 24 to the small disc data-accessing position 22 until the sensing module 14 has sensed the small disc 24. While the large disc 18 can be inserted into the middle region only of the disc slot 12, the small disc 24 can be inserted into a side region instead of the middle region of the disc slot 12. In operation, the roller 14 has to maneuver the small disc 24 inserted into the side region of the disc slot 12 to convey the small disc 24 to the small disc data-accessing position 22 accurately. Therefore, the small disc 24 will slips and rotates while it is conveyed into the small disc data-accessing position 22. This may harm or scratch the small disc 24.

Please refer to FIG. 3, which is a flowchart of the optical disc drive 10 conveying a disc according to the prior art. In step 102, a disc (large or small) is inserted into the disc slot 12; In step 104, the sensing module 16 senses the disc; In step 106, the roller 14 conveys the disc to a disc data-accessing position (the large disc data-accessing position 20 or the small disc data-accessing position 22) as long as the sensing module 16 has sensed the disc no matter whether the disc is inserted into the side region or the middle region of the disc slot 12.

In order to solve the problem that the roller 14 has to accommodate the small disc 24 if it is inserted into the side region of the disc slot 12, the optical disc drive 10 of the prior art, as shown in FIG. 4, may have a label of “8 cm disc in” marked on a front end of the disc slot 12 to remind users to follow the label to insert the small disc 24 into the middle region of the disc slot 12. Additionally, the optical disc drive 10 of the prior art may further comprise a costly dedicated guiding mechanism installed in front of the roller 14 for guiding the small disc 24 into the middle region of the disc slot 12, so that the roller 14 conveys the small disc 24 to the small disc data-accessing position 24 without error.

However, there are still some careless users who may ignore the label and insert the small disc 24 into any position beyond the middle region of the disc slot 12 at will, the roller 14 therefore still has to convey the small disc 24 resulting in the disc rotating or slipping within the roller.

### SUMMARY OF INVENTION

It is therefore a primary objective of the claimed invention to provide an optical disc drive with a disc-position detecting device to overcome the drawback that a roller has to accommodate disc slip if the disc is not inserted into a predetermined region of a disc slot.

According to the claimed invention, the optical disc drive has a disc slot for a disc to be inserted into, a roller for conveying the disc inserted into the disc slot, and OLE_LINK1 the disc-position sensing device OLE_LINK1 comprising a plurality of sensing modules installed inside the disc slot for sensing a position where the disc is inserted into the disc slot. The roller conveys the disc when all of the sensing modules have sensed the disc.

According to the preferred embodiment, the disc-position sensing device comprises two sensing modules installed adjacent to a middle region of the disc slot in an optical disc drive.

It is an advantage of the claimed invention that an optical disc drive with a disc-position detecting device to detect a position that a disc is inserted into a disc slot conveys the disc without slippage.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a slot-loading optical disc drive according to the prior art.

FIG. 2 is a schematic diagram showing the slot-loading optical disc drive shown in FIG. 1 conveying a small disc according to the prior art.

FIG. 3 is a flowchart of the slot-loading optical disc drive shown in FIG. 1 conveying a disc according to the prior art.

FIG. 4 is a schematic diagram of another slot-loading optical disc drive having a label marked according to the prior art.

FIG. 5 and FIG. 6 are two schematic diagrams of a slot-loading optical disc drive of the preferred embodiment according to the present invention.

FIG. 7 is a flowchart showing the slot-loading optical disc drive shown in FIG. 5 conveying a disc according to the present invention.

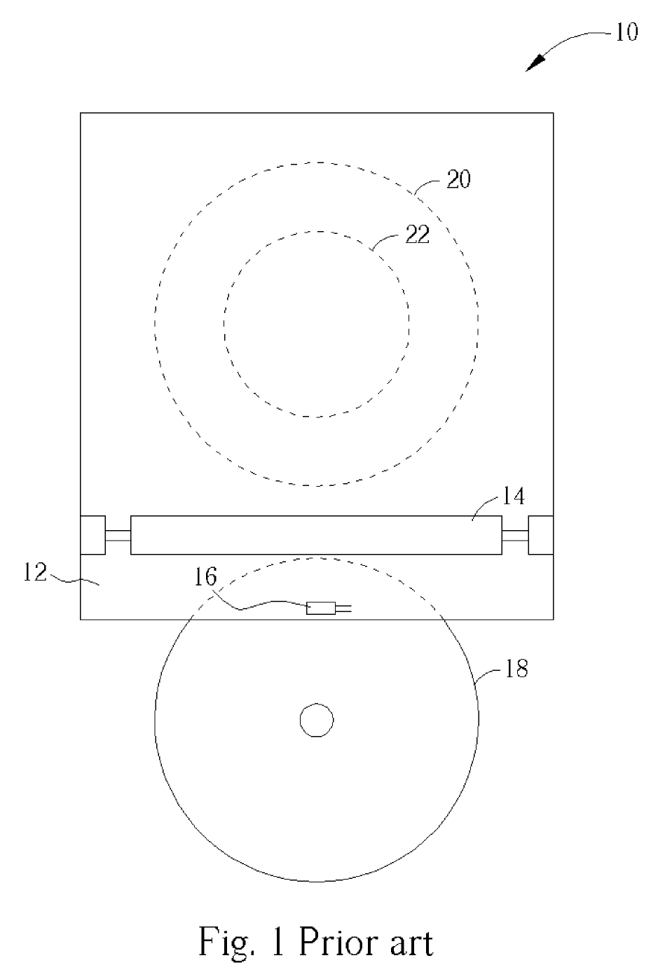

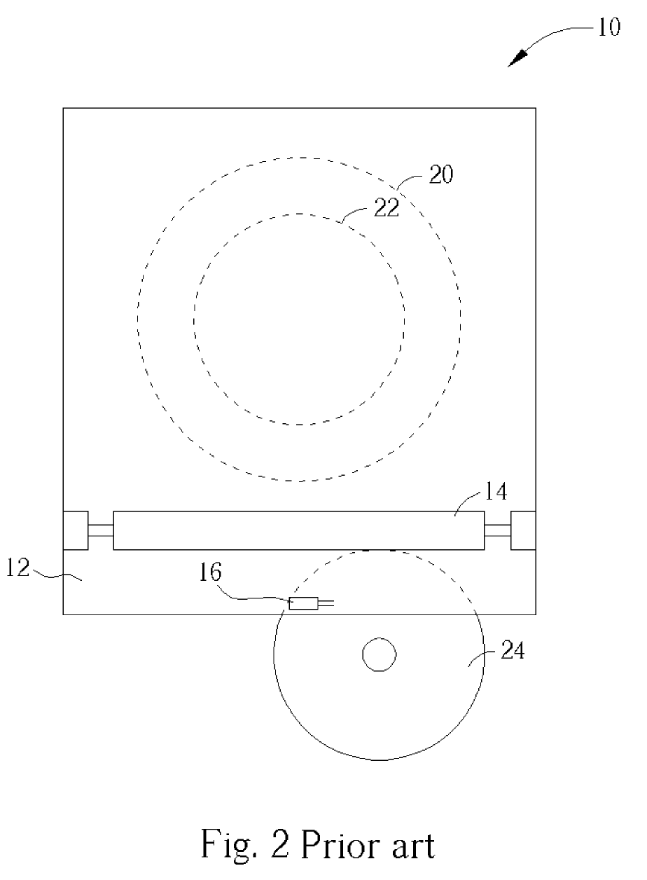

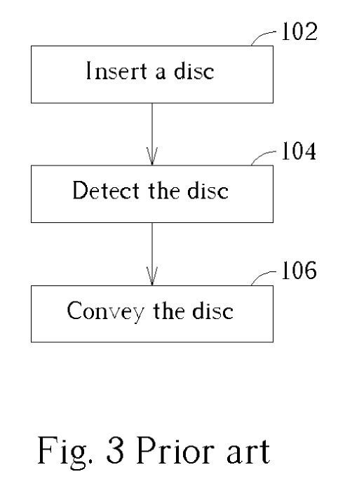

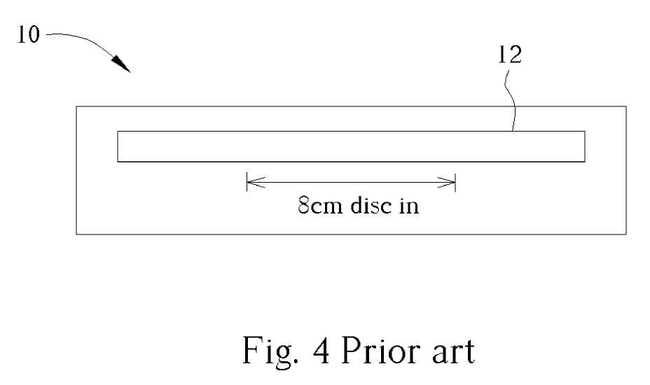

### DETAILED DESCRIPTION

As described previously, since a roller of an optical disc drive usually conveys a large disc to a large disc data-accessing position without slip, only a small disc is used hereafter as an example to demonstrate how an optical disc drive of the present invention conveys a disc. In addition to the small disc, the optical disc drive of the present invention is of course capable of accommodating a large disc as well.

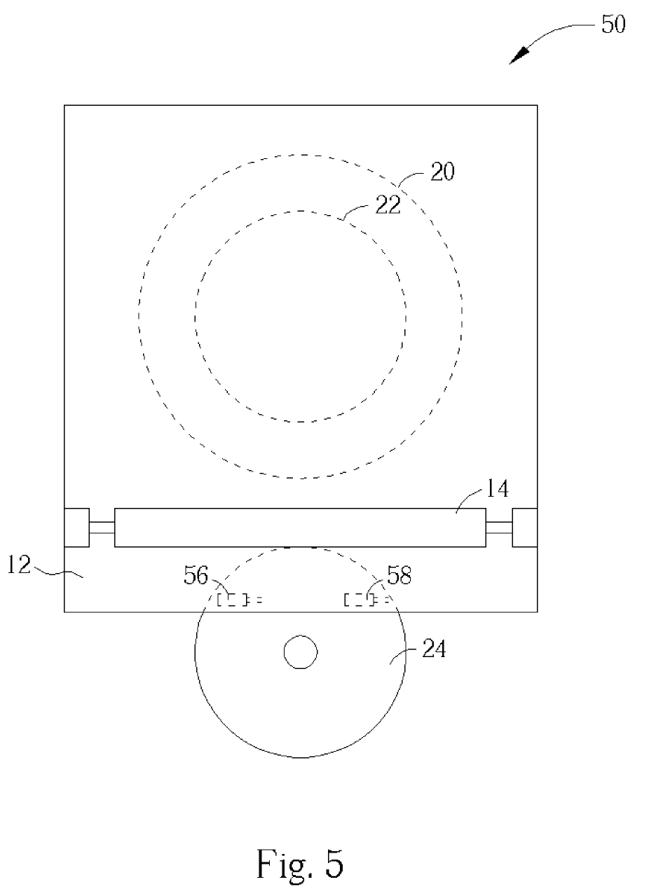

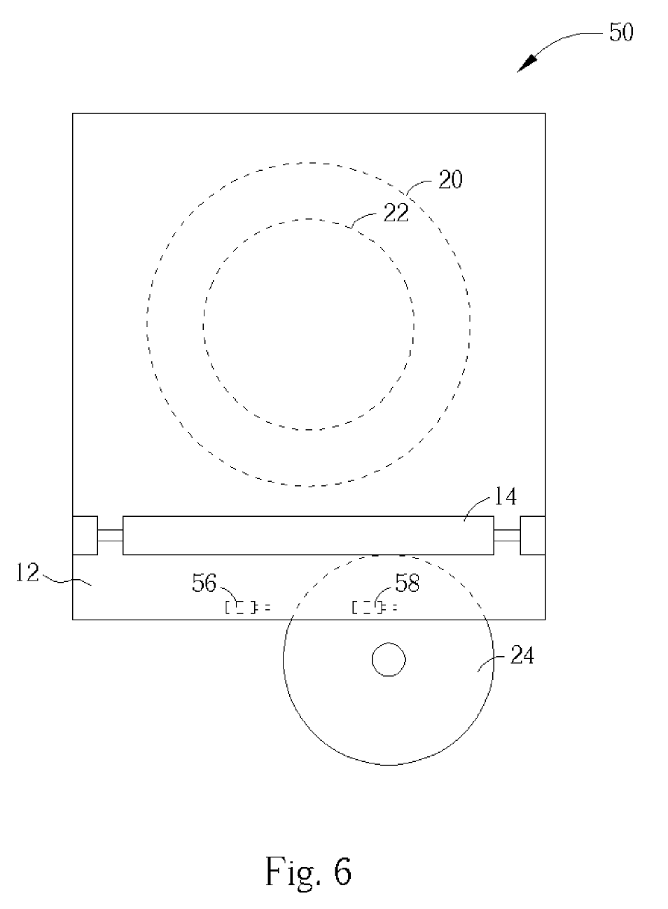

Please refer to FIG. 5 and FIG. 6, which are two schematic diagrams of an optical disc drive 50 of the preferred embodiment according to the present invention. In FIG. 5, a small disc 24 in inserted into the middle region of a disc slot 12. In FIG. 6, the small disc 24 is inserted into the side region of the disc slot 12. In addition to the disc slot 12, a roller 14, a large disc data-accessing position 20, and a small disc data-accessing position 22, the optical disc drive 50 further comprises a disc-position detecting device, which comprises a sensing module 56 installed on one side of the center of the disc slot 12 as shown in FIG. 5, and a sensing module 58 installed on the other side of the center of disc slot 12 according to FIG. 5. The roller 14 conveys the small disc 24 to the small disc data-accessing position 22 when both of the sensing modules 56 and 58 have sensed the small disc 24.

According to the preferred embodiment, each of the sensing modules 56 and 58 comprises a light source for emitting light and a light sensor for sensing the light emitted by its corresponding light source. The roller 14 does not convey the small disc 24 to the small disc data-accessing position 24 until the small disc 24 is inserted into a predetermined position, upon which the small disc 24 covers both of the light sensors from receiving the light emitted from their corresponding light sources.

The operation of the optical disc drive 50 is described as follows. The optical disc drive 50 together with the small disc 24 shown in FIG. 6 is illustrated here as an example first. The roller 14 does not convey the small disc 24 to the small disc data-accessing position 22 until both of the sensing modules 56 and 58 have sensed the small disc 24, that is, until the sensing modules 56 and 58 sense the small disc 24 concurrently. In FIG. 6 only the sensing module 58 has sensed the small disc 24, and so the roller 14 does not convey the small disc 24 even though the small disc 24 is inserted into the disc slot 12 and has the front end adjacent to the roller 14. Therefore, the roller 14 will not convey the small disc 24 inserted into a position other than the middle region of the disc slot 12 to the small disc data-accessing position 22. On the contrary, if the small disc 24 is inserted into the middle region rather than the side region of the disc slot 12, as shown in FIG. 5, and when the small disc 24 is inserted to a position pretty close to the roller 14, both of the sensing modules 56 and 58 sense the small disc 24 and then the roller 14 correspondingly conveys the small disc 24 to the small disc data-accessing position 22. Since the roller 14 operates only when the sensing modules 56 and 58 have sensed that the small disc 24 is inserted into the middle region of the disc slot 12, that is, the roller 14 conveys only those small discs inserted into the middle region to the small disc data-accessing region 22, the roller 14 of the optical disc drive 50 conveys the small disc 24 without slip.

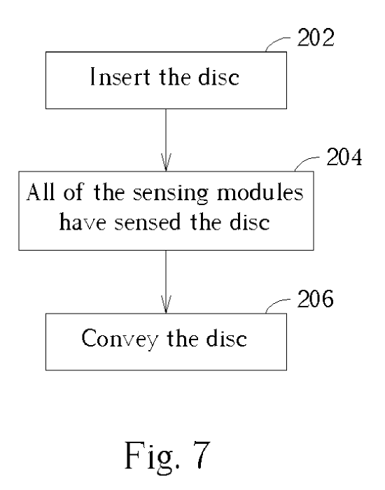

Please refer to FIG. 7, which is a flowchart of the optical disc drive 50 conveying a disc according to the present invention. In step 202, a disc, i.e. the large disc 18 or the small disc 24, is inserted into the disc slot 12; In step 204, the sensing modules 56 and 58 sense the disc inserted into the disc slot 12; In step 206, the roller 14 does not convey the disc to the small disc data-accessing position 22 (or the large disc data-accessing position 20) until both of the sensing modules 56 and 58 have sensed the disc. Note that the small disc 24 has to be inserted into the middle region of the disc slot 12 to be sensed by the disc-position detecting device of the optical disc drive 50.

The disc-position detecting device of the optical disc drive 50 shown in FIG. 5 and FIG. 6 comprises exactly two sensing modules 56 and 58. However, an optical disc drive of the present invention can comprise more than two sensing modules to detect a position where a disc is inserted into a disc slot as accurately as possible. In addition, instead of a roller, an optical disc drive of the present invention can comprise another kind of conveying mechanism to convey a disc. And based on the status of the plurality of sensing modules, the optical disc drive can have the information of where the disc is inserted and choose a proper conveying method of mechanism accordingly.

According to the preferred embodiment, the sensing modules 56 and 58 have a distance between them corresponding to a size of the small disc 24. In operation, when the small disc 24 is inserted into the disc slot 12 and has a front end adjacent to the roller 14, the small disc 24 starts to cover the light sensors and prevent them from receiving the light emitted from their corresponding light sources.

According to the preferred embodiment, if both of the sensing modules 56 and 58 have sensed a disc, the roller 14 conveys the disc; otherwise the roller 14 does nothing. However, the roller 14 of an optical disc drive of the present invention can be controlled to perform other proper operations based on the inserted position of a disc such as reject a disc by rolling itself in a reversed manner if only one of the sensing modules 56 and 58 has sensed the disc. In detail, if the small disc 24 is inserted into the side region rather than the middle region of the disc slot 12, the roller 14 not only does not convey the small disc 24 to the small disc data-accessing position 22, the roller also rejects the small disc 24 out from the disc slot 12 by rolling in the reverse manner.

Additionally, an optical disc drive of the present invention can further comprise an alarm for warning a user by generating an illuminating alarm signal when the user does not insert a disc into the middle region of the disc slot 12. According to the preferred embodiment, the alarm is a light-emitting diode (LED).

In operation, when at least one of the sensing modules has sensed the disc and at least another one of the sensing modules does not sense any disc, the disc is detected to be inserted into a position outside of the middle region of the disc slot 12, and the roller 14 does nothing or performs other proper operations such as rejects the disc out from the disc slot 12, or the alarm (or an LCD panel having a function the same as that of the alarm) reminds the user to reinsert the disc into the middle region of the disc slot 12.

In contrast to the prior art, the present invention can provide an optical disc drive having a roller, a disc slot, and a disc-position detecting device for detecting a position where a disc is inserted into the disc slot. Therefore, the roller conveys the disc without slip or error only when the disc-position detecting device has detected that the disc is inserted into a predetermined position of the disc slot.

Those skilled in the art will readily observe that numerous modifications and alterations of the device and method may be made while retaining the teachings of the invention. Accordingly, the above disclosure should be construed as limited only by the metes and bounds of the appended claims.

1. An optical disc drive with a disc-position sensing device, the optical disc drive comprising:
a disc slot for a disc to be inserted into;
a roller for conveying the disc inserted into the disc slot; and
the disc-position sensing device comprising a plurality of sensing modules installed inside the disc slot for sensing a position where the disc is inserted into the disc slot;
wherein the roller conveys the disc when all of the sensing modules have sensed the disc.

2. The optical disc drive of claim 1, wherein the disc-position sensing device comprises two sensing modules.

3. The optical disc drive of claim 2, wherein either of the sensing modules comprises a light source for emitting light and a light sensor for sensing the light emitted from the light source, and the roller conveys the disc when both of the light sensors do not sense the light from their corresponding light sources.

4. The optical disc drive of claim 2, wherein the sensing modules are installed to have a distance between them corresponding to a size of the disc, so that either of the sensing modules cannot sense the disc unless the disc is inserted into a middle region of the disc slot.

5. The optical disc drive of claim 2, wherein one of the sensing modules is installed on one side of the center of the disc slot, and the other one of the sensing modules is installed on the other side of the center of the disc slot.

6. The optical disc drive of claim 2, wherein the disc slot comprises a middle region, and both of the sensing modules are installed adjacent to the middle region of the disc slot.

7. The optical disc drive of claim 1, wherein the roller rejects the disc when at least one of the sensing modules has sensed the disc and at least another one of the sensing modules does not sense the disc.

8. The optical disc drive of claim 1 further comprising an alarm for generating a warning signal when at least one of the sensing modules has sensed the disc and at least another one of the sensing modules does not sense the disc.

9. The optical disc drive of claim 8, wherein the alarm is a light-emitting diode (LED).

10. A method for controlling a roller to convey a disc inserted into a disc slot of an optical disc drive comprising a disc-position sensing device comprising a plurality of sensing modules, and the method comprising:
receiving the disc at the disc slot; and
controlling the roller to convey the disc when all of the sensing modules of the disc-position sensing device have sensed the disc.

11. The method of claim 10, wherein the disc-position sensing device comprises two sensing modules.

12. The method of claim 11, wherein either of the sensing modules comprises a light source for emitting light and a light sensor for sensing the light emitted from the light source, and the roller does not convey the disc until both of the light sensors do not sense the light from their corresponding light sources.

13. The method of claim 11, wherein the sensing modules are installed to have a distance between them corresponding to a size of the disc, so that either of the sensing modules can sense the disc if the disc is inserted into a middle region of the disc slot.

14. The method of claim 11, wherein one of the sensing modules is installed on one side of the center of the disc slot, and the other one of the sensing modules is installed on the other side of the center of disc slot.

15. The method of claim 11, wherein the disc slot comprises a middle region, and both of the sensing modules are installed adjacent to the middle region of the disc slot.

16. The method of claim 10, wherein the roller rejects the disc when at least one of the sensing modules has sensed the disc and at least another one of the sensing modules does not sense the disc.

17. The method of claim 10 further comprising an alarm for generating a warning signal when at least one of the sensing modules has sensed the disc and at least another one of the sensing modules does not sense the disc.

18. The method of claim 17, wherein the alarm is a light-emitting diode (LED).
